(19) United States
(12) Patent Application Publication
(10) Pub. No.: US 2006/0184603 A1
(43) Pub. Date: Aug. 17, 2006

(54) Zero detect in partial sums while adding

(76) Inventors: Son Dao Trong, Stuttgart (DE); Mark Alan Erle, Poughkeepsie, NY (US); Bruce Martin Fleischer, Bedford Hills, NY (US); Juergen Haess, Schoenaich (DE); Michael Robert Kelly, Wappingers Falls, NY (US); Klaus Michael Kroener, Boeblingen (DE); Martin Stanley Schmookler, Austin, TX (US); Eric Mark Schwarz, Gardiner, NY (US)

Correspondence Address: IBM CORPORATION;INTELLECTUAL PROPERTY LAW, 11400 BURNET ROAD, AUSTIN, TX, 78758, US

(21) Appl. No.: 11/056,036

(22) Filed: Feb. 11, 2005

(51) Int. Cl. G06F 7/52

(52) U.S. Cl. 708/620

(57) ABSTRACT

The present invention relates to a method and circuit for performing multiply-operations in an arithmetic unit of a computer processor. In a multiplier thereof, zero detection of the resulting product bit string (22) is needed for a proper setting of condition code and overflow status information. Zero detection according to prior art decreases the calculation speed in the multiplier. In order to provide a method and respective electronic circuit, wherein the zero detection is earlier completed, it is proposed to use a leading zero anticipation (LZA) hardware—i.e., an LZA circuit (40), which exists usually anyway in floating point processor adders for calculating the number of leading zeros for operand normalization purposes—for performing a zero detection of the product by aid of the partial results (16, 17) emerging at the output of the Wallace tree of the multiplier. MSB-most and LSB-most margin bits (24, 26) of the partial (16, 17) results which cannot be processed by the LZA circuit (40), are read directly from the final product bit string (22).

### 1. BACKGROUND OF THE INVENTION

1.1. Field of the Invention

The present invention relates to a method and circuit for performing multiply-operations in an arithmetic unit of a computer processor.

1.2. Description and Disadvantages of Prior Art

When performing a multiply operation with a multiplicand A and a multiplier C, a product P=A*C is calculated by adding up a plurality of partial products, for example in a Wallace tree based procedure and architecture. A schematic overview on such an exemplary prior art multiplier implementation is given in FIG. 1. The respective control flow is given in FIG. 3.

In FIG. 1, operands A and C are assumed to be 64 bit wide. The operands are decoded in a decode unit 12. A plurality of 33 product terms, i.e. the above partial products, are generated, each term being 128 bits wide. These partial products are added in the Wallace tree 14, wherein a plurality of partial sums are generated by respectively adding three partial products and generating two partial sums in a tree-like iteration. In this technique, the Wallace tree 14 ends with two “partial results”, the terms 16, 17, denoted as SOE and COE, to be added in a separate 128-bit adder 18. The addition in this final adder 18 yields the product result:
P=A*C.

The prior art Wallace tree 14 is schematically depicted in FIG. 2. While running from the upper leave nodes down to the primary node at the bottom of the figure the partial products 0 to 32 are added in respective Carry-Select Adders denoted as CSA, followed by a row number and the level number. Each term to be added is 128 bits wide. The partial results, here named as COE and SOE must be added in adder 18, see FIG. 1.

In order to be able to perform a proper setting of condition code and overflow control signals in the above multiplication scheme, it is required to detect zeros in the end result of the multiplication.

As shown in FIG. 1 and FIG. 3, the prior art arithmetic unit in FIG. 1 performs the add process 110 in adder 18 and begins the zero detection process 120 in a 32-bit NOR gate 19, after having completed the add process. A bitstring “zero” control signal 20 is generated, which is “true” when all bits of the product bit string are zero.

Then, by aid of the zero-detect signals the condition code and overflow setting in step 130 can be performed.

Since this logic 19 is slow it adds either one cycle to the condition and overflow setting or makes the timing of the pipeline cycle longer. In high performance computer this can not be accepted because all cycles are “squeezed” out to the limit.

1.3. Objectives of the Invention

It is thus an objective of the present invention to provide a method and respective electronic circuit, wherein the zero detection is completed earlier.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

The present invention is based on the idea to use existing leading zero anticipation (LZA) hardware—i.e., an LZA circuit, which exists usually in floating point processor adders for calculating the number of leading zeros for operand normalization purposes—also for performing a partial sum zero detection in multiply operations.

More precisely, according to the invention a method and respective system circuit are disclosed for performing a multiply-operation in an arithmetic unit of a computer processor, wherein zeros of the product bit string must be detected, wherein the product bit string is built by the addition of respective two add-operands, wherein a) a LZA circuit is fed with two corresponding substrings of the add-operands excluding their two MSB-most and the LSB-most margin bits, b) reading said two MSB-most and the LSB-most margin bits directly from the addition result of the two add-operands, and c) detecting a full zero product bit substring, when both, LZA circuit and said two MSB-most and the LSB-most margin bits from the addition result yield zero results.

According to the invention, the zero detection in partial sums is basically done by an LZA circuit dedicated for different purposes, i.e., for operand normalization, and can be started in parallel with the addition of the above-mentioned partial sums. This is advantageous, as the LZA algorithm and hardware, is existent on the chip anyway as it is needed for the normalization of floating point numbers. The LZA circuit is run thru in parallel to the addition of the Wallace-tree partial results. One drawback of this algorithm is that the number of leading zeros is imprecise by one, e.g. a final correction is needed by checking the MSB of the final result.

Using the LZA output string, the partial zero result detection can be generated almost at the same time the result of the addition is generated. The LZA algorithm is disclosed for example in “Proceedings of the 15^{th} IEEE Symposium on Computer Arithmetic (Arith'01) 1063-6889/01, 2001, IEEE, hereby incorporated by reference.

The advantage results that the adding in the final adder and the zero detect may be performed concurrently, and not subsequently.

Of course the LZA output bit string can be used for detecting different cases, as for example only “all 1” cases, with a respective post-connected evaluation logic analogously applied to evaluation logic 42 in FIG. 4.

### 3. BRIEF DESCRIPTION OF THE DRAWINGS

The present invention is illustrated by way of example and is not limited by the shape of the figures of the drawings in which:

FIG. 1 is a block diagram of a prior art multiplication scheme, with exemplary 64-bit wide operands A, C,

FIG. 2 is a block diagram of a prior art Wallace tree 14 as used in the above FIG. 1 scheme,

FIG. 3 is a prior art control flow diagram according to the scheme given in FIG. 1,

FIG. 4 is a block diagram of a multiplication scheme in accordance with the present invention, having exemplary 64-bit wide operands A, C,

FIG. 5 is a control flow diagram of the present invention according to the scheme given in FIG. 4, and

FIG. 6 is a detail view on the control flow for evaluating the LZA-result.

### 4. DETAILED DESCRIPTION OF THE PREFERRED EMBODIMENT

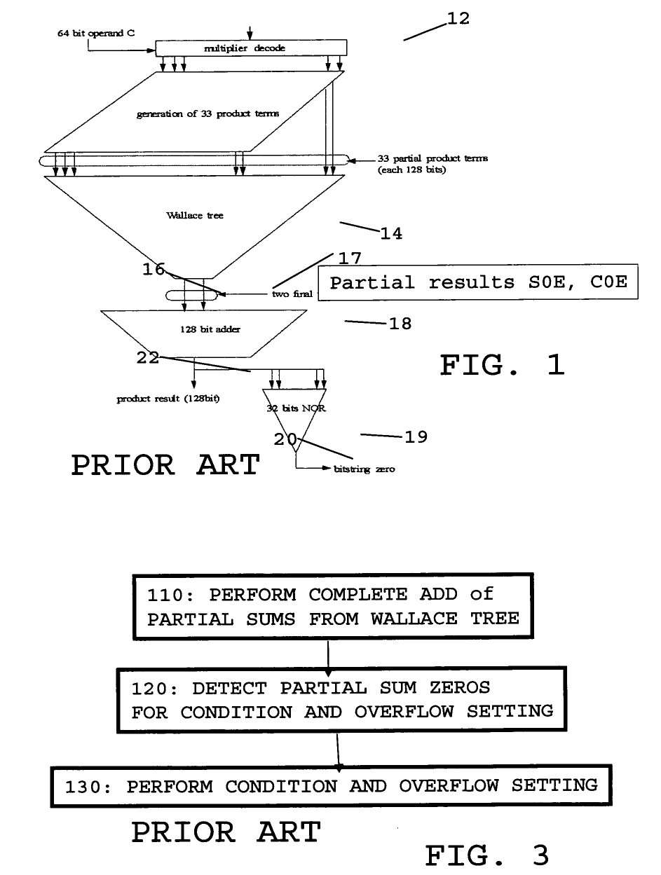

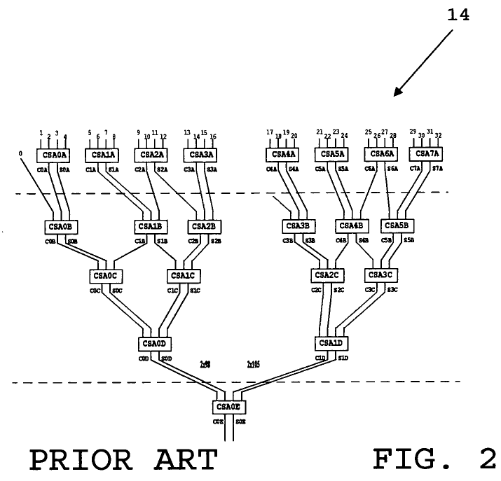

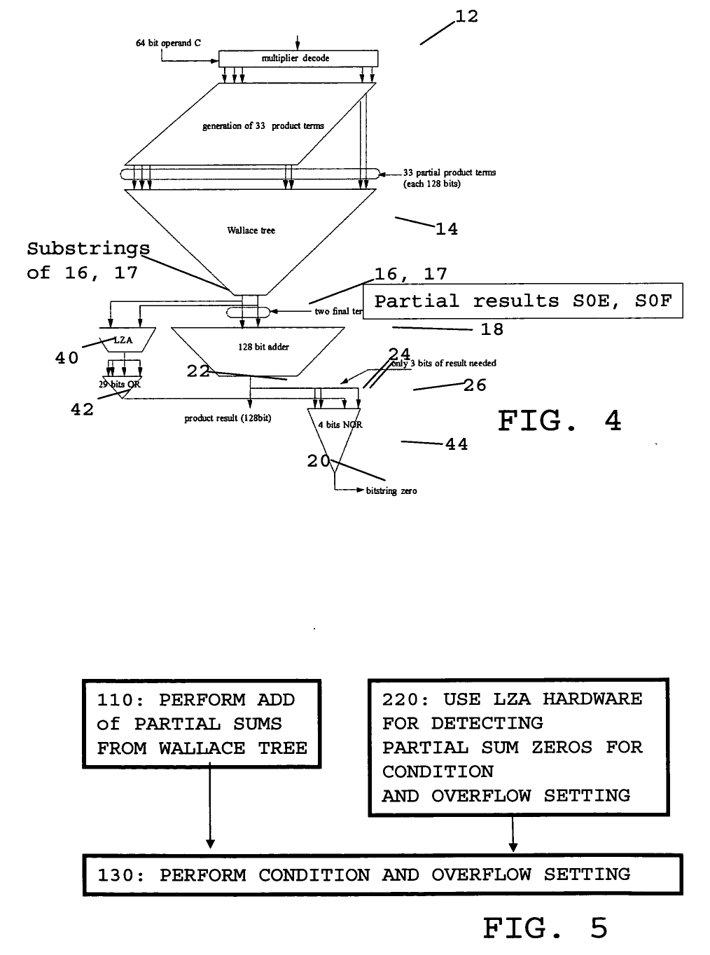

With general reference to the figures and with special reference now to FIG. 4 the basic circuit scheme as described with reference to FIG. 1 is enriched by the above-mentioned LZA circuit 40, into which substrings of the two operands SOE and COE of a predetermined bit width are input. Note that the denotations SOE and COE are taken from the Wallace tree scheme and do not delimit the scope of the invention.

The LZA circuit 40 is output-connected to the input of an OR gate 42, which has as many inputs as is the bit width of the LZA-subjected substring. In the example this width is assumed to comprise bits 32 to 63, i.e., a width of 32 bits. The single output of the OR gate 42 is fed as an input for a 4-bit NOR gate 44. The other three input bits for the NOR gate 44 are fetched from the add-result 22 coming from the adder 18 output. These bits are the two most significant bits (MSB) and the least significant bit (LSB) of the addition in adder 18.

This LZA circuit logic 40 generally enables the generation of a bit string which can be used to count the number of leading zeros or leading ones in a floating point or fixed point addition without having to perform the addition actually. According to this inventional embodiment the LZA circuit 40 is used to speed up the detection of a partial result of an addition to be zero, for example to speed up the determination if the partial result bits 32 to 63 are all zero. Note that also bits 16 to 31 or any other bit range of interest could be subjected to the LZA algorithm.

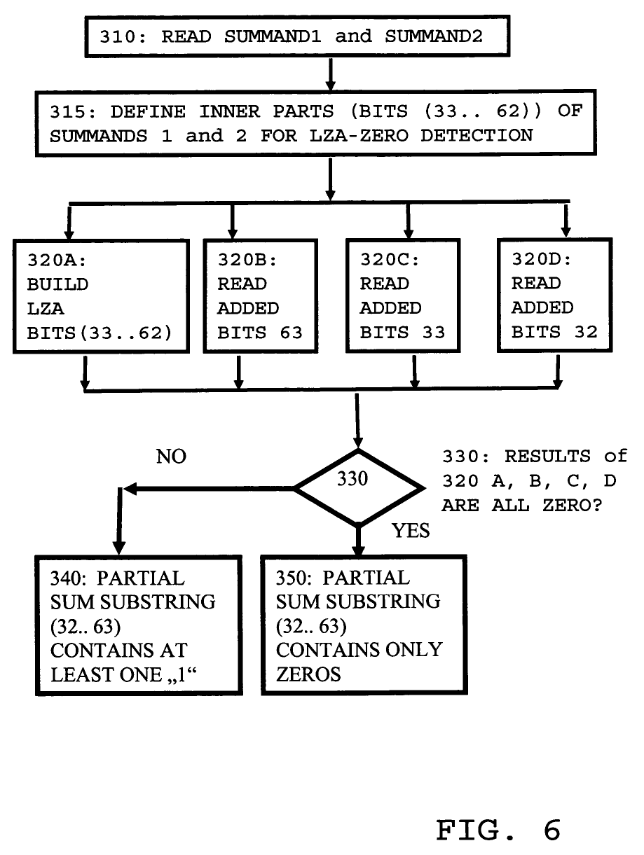

As shown from FIG. 5′ the addition step 110 performed in adder 18 and the LZA circuit used in step 220 to detect whether the partial sums to be zero or not, are basically done in parallel and started concurrently.

As shown from FIG. 6, which is a detail view of the method control flow of the present invention, in a step 310 the two summand operands SOE and COE, i.e., the two partial results 16, 17 are read from the output register of the Wallace circuit 14. In a next step 315 the inner parts (bits from summand) of interest are determined as described above, i.e. the three margin bits are excluded from LZA operation, as each bit from the LZA string is calculated from three consecutive bits of the two summands. In this example, for the partial result from bit 32 to 63, only bits 33 to 62 can be used to detect the string of all zeros to guarantee that none of the bits outside of this range affects the decoding.

This is expressed in the following formula:
res(32−63)=0<=>NOT(res(32) OR res(33) OR lza(33−62) OR res(63))

The MSB result bits 32 and 33—denoted with reference sign 24 (see FIG. 4)—are needed to guarantee that the string is really a string of continuous leading zeros because the LZA algorithm is imprecise at the last MSB position. The result bit 63—denoted with reference sign 26—is needed to take account for the carry in into the bit string range.

If the LZA result evaluation done in OR gate 42 yields that the LZA bits 33-62 are all zeros, see step 320 A, then it is further required to check the final result bits no. 32, 33 and 63 also to be zero or not, see steps 320 B, 320 C, 320 D. If all of them are zero, then the partial sum is zero. In FIG. 6 all checks are depicted to be done concurrently. As however, the check results from steps 320 A to D are in general obtained subsequently, the zero-detect procedure can be finished when the firstly arriving check result yields that a partial sum substring contains at least one “1”, see step 340. Otherwise in step 350, a zero case is detected when all checks 320 A to 320D yield a zero.

As a person skilled in the art will appreciate, the LZA result bit string can be computed quite fast in relation to the prior art NOR gate 19 (FIG. 1). Thus, it is advantageous to use this bit string in order to detect a partial bit string of zeros in the end result of the multiplication.

The detection timing requirement can be reduced to a simpler 4-way NOR gate as it is depicted in gate 44, since the lza bit string is available very early before the result, as compared to prior art having a 32-way NOR to generate the partial result zero signal. When using the binary tree structure, the prior art needs two stages of a 4-way OR followed by one stage of 4-way NOR (see FIG. 1 the 32-bit NOR gate 19) compared to just one stage 44 of 4-way NOR that can be obtained with the implementation of the present invention, see FIG. 4. This relationship gets even more extreme when we need to generate a partial sum zero of 64 bit as for the longer instruction of the PowerPC architecture, for example. In this case prior art would need four stages.

The techniques of the present invention can also be used to detect a partial string of ones because the LZA algorithm is valid for both leading string of ones or zeros. This may be used advantageously by a person skilled in the art would, wherein bit patterns are analyzed to be all ones or all zeros in a predetermined bit string range. Examples are given by an XML parser, or a pattern detection tool, be that graphics-based or text-based.

1. A method for performing a multiply-operation in an arithmetic unit of a computer processor, wherein zeros of the respective product bit string must be detected, and the product bit string is built by an addition of respective two add-operands, comprising the steps of:
a) feeding (320A) a LZA circuit (40) with two substrings of the add-operands corresponding to each other in bit width and bit position excluding their two MSB-most (24) and the LSB-most (26) margin bits;
b) reading (320B, 320C, 320D) said two MSB-most (24) and the LSB-most (26) margin bits directly from the addition result (22) of the two add-operands (16, 17); and
c) detecting (350) a full zero product bit substring, when both, LZA circuit (40) and said margin bits (24, 26) from the addition result yield zero results.

2. The method according to claim 1, wherein in step c) a full “1” substring is detected, when both, the LZA circuit and the margin bit positions yield “1” results.

3. A multiplier unit comprising an adder circuit (18) processing partial results (16, 17) to yield the end result of a multiplication, comprising:
a) a Leading Zero Anticipator (LZA) circuit (40) connected to be input with at least substrings of said partial results (16, 17) corresponding to each other in bit width and bit position excluding their two MSB-most (24) and the LSB-most (26) margin bits; and
b) an LZA result evaluation logic (42) determining if the LZA output bit string comprises either only ZERO or ONE bit values; and
c) a further evaluation logic (44) determining if the two MSB-most bits (24) and the LSB-most bit (26) of the addition result (22) are concurrently either only ZERO or ONE.

4. A multiplier unit according to claim 3 wherein said further evaluation logic detects a full “1” substring when both said LZA circuit and said margin bit positions yield “1” results.

5. A data processing system including a multiplier unit with an adder circuit that processes partial results to yield an end result of a multiplication, comprising:
a) LZA circuit that receives substrings of said partial results corresponding to each other in bit width and bit position, exclusive of their most significant bits and least significant bits;
b) LZA result evaluation logic that determines if an output bit string from said LSA circuit includes either only ZERO bit values or only ONE bit values; and
c) evaluation logic that determines if the two most significant bits and the one least significant bit of the addition result are concurrently either only ZERO or only ONE.

6. A data processing system according to claim 5 wherein said evaluation logic detects a full “1” substring when both said LZA circuit and said two most significant bits and said least significant bit are “1” values.
